(19) United States
(12) Patent Application Publication
(10) Pub. No.: US 2006/0090395 A1
(43) Pub. Date: May 4, 2006

(54) Compact synthesis gas generation system

(76) Inventors: Edward J Rode, Surrey (CA); Marie Taponat, Vancouver (CA); Surajit Roy, Burnaby (CA); Mark E Grist, Surrey (CA)

Correspondence Address: KLARQUIST SPARKMAN, LLP, 121 SW SALMON STREET, SUITE 1600, PORTLAND, OR, 97204, US

(21) Appl. No.: 10/543,248

(22) PCT Filed: Jan. 29, 2004
(86) PCT No.: PCT/US04/02853

§ 371 Date: Jul. 22, 2005

Related U.S. Application Data
(60) Provisional application No. 60/444,171, filed on Jan. 30, 2003.

(51) Int. Cl. B01J 7/00; B01J 8/00

(52) U.S. Cl. 48/61; 48/127.9

(57) ABSTRACT

Compact synthesis gas generation systems are provided incorporating effective gas purification means to control the purity of the desired components of the synthesis gas product. The compact synthesis gas generation systems of the invention may particularly incorporate compact rotary pressure swing adsorption systems to accomplish the required gas purification. The compact synthesis gas generation systems of the invention may be adapted to utilize various fuel feedstock's and reforming reactor technologies known generally in the art, and are particularly suitable for use in applications where equipment size is desirably minimized, such as mobile applications.

### CROSS REFERENCE TO RELATED APPLICATION

This application claims the benefit of U.S. Provisional Patent Application No. 60/444,171 filed Jan. 30, 2003, which is incorporated herein by reference.

### FIELD

The present disclosure relates to synthesis gas generation systems, and more particularly to compact synthesis gas generation systems adapted to provide synthesis gas to an ammonia reactor for use in compact or mobile applications.

### BACKGROUND

The production of ammonia gas for use in chemical and industrial processes is well known in the prior art. Various different types of generation systems have been developed for supplying synthesis gas to be used as a feedstock for generating ammonia in an ammonia reactor vessel or the like. Such synthesis gas generation systems function to deliver a synthesis gas mixture containing hydrogen and nitrogen gas constituents at approximately the 3:1 stoichiometric ratio required for generating ammonia gas. Ammonia synthesis gas generation systems of the prior art have additionally included means for separating and purifying the hydrogen and nitrogen constituents of the synthesis gas mixture to reduce concentrations of diligent gas components, and gas components which may be deleterious to the production of ammonia, or downstream processes using the ammonia gas.

In the ammonia synthesis gas generation systems of the prior art, the inclusion of effective separation and purification means to purify the hydrogen and nitrogen gas constituents of the synthesis gas has been limited to large scale stationary systems, most generally installed in connection with large scale stationary ammonia production plants. This is in large part due to the large size and complexity of conventional gas separation apparatus, such as solenoid-valued pressure swing adsorption systems, suitable to separate and purify the hydrogen and nitrogen constituents of the synthesis gas. In the case of compact ammonia production systems, and particularly compact ammonia production systems potentially suitable for mobile applications, the systems of the prior art have not included effective or economically attractive means to purify the hydrogen and nitrogen synthesis gas constituents, and to control the concentration of deleterious and diligent gas components of the synthesis feed gas. Furthermore, ammonia production systems of the prior art require a substantial warm-up time period in order to reach desired operating conditions and are therefore unsuited for many mobile applications which require systems to reach desired operating conditions very quickly following start-up.

### DISCLOSURE OF THE INVENTION

It is an objective of the present disclosure to address some of the shortcomings of the ammonia synthesis gas (syngas) generation systems of the prior art. It is a further objective of the present disclosure to provide a compact syngas generation system incorporating effective gas purification means to control the purity of the desired components of the syngas product. It is yet a further objective of the present disclosure to provide a compact ammonia syngas generation system incorporating effective gas separation and/or purification means suitable for use in applications where equipment size must be minimized, such as mobile applications.

In a first embodiment according to the present disclosure, a compact ammonia syngas generation system for supplying syngas to an ammonia reactor is provided which comprises a reforming reactor fluidly coupled to a downstream compact gas separation means. In such an embodiment, the reforming reactor operates to produce a reformate gas containing hydrogen and nitrogen components from a suitable hydrocarbon fuel feedstock, providing the reformate gas to the compact gas separation means. The compact gas separation means operates to purify the desired hydrogen and nitrogen constituents of the reformate gas to deliver a syngas product having enriched hydrogen and nitrogen components in desired ratios, such as approximately a 3:1 stoichiometric quantity, for use in a downstream reactor, while separating deleterious or diligent components, such as may be provided by the reformate, to reduce their concentration in the product syngas mixture.

Suitable reforming reactors for use in the system according to the first disclosed embodiment of the disclosure above may include catalytic partial oxidation reactors (CPO), or auto-thermal reforming reactors (ATR), which are known to reform hydrocarbon fuels, such as diesel fuel, gasoline, natural gas, propane, ethanol and methanol, in the presence of air, to produce reformate gas containing hydrogen and nitrogen components. Suitable compact gas separation means may include gas separation membranes or compact pressure swing adsorption (PSA) modules, and more particularly compact rotary PSA modules. Such compact rotary PSA modules generally may be characterized as operating at relatively high cycle speeds compared to conventional PSA systems, such as greater than about one adsorption cycle per minute and up to at least 150 adsorption cycles per minute, and more typically from about 20 to about 60 adsorption cycles per minute, and incorporating correspondingly rapid cycling rotary valve technology, these features together enabling more productive use of adsorbent materials, and allowing reduction in the size of the PSA resulting in a compact PSA system relative to conventional PSA technology. The compact rotary PSA systems incorporated in the inventive syngas generation systems may incorporate conventional granular adsorbent materials in adsorber beds, or may advantageously incorporate multi-layer parallel passage adsorbent beds with integrated adsorbent materials, such as are disclosed in U.S. Pat. Nos. 6,063,161 and 6,451,095, and U.S. application Ser. No. 10/039,552, all to Keefer, et. al., the combined contents of which are incorporated herein by reference in their entirety. The adsorbent beds in the above compact rotary PSA modules may contain adsorbent materials as known in the prior art such as molecular sieves including, without limitation, zeolites and titanosilicates, aluminas, silicas, activated carbon and carbon molecular sieves, other adsorbent materials, and combinations thereof, which may be selected according to their ability to adsorb contaminants, undesired or diluent components of the reformate gas mixture, and thereby relatively enrich the gas components desired in the product syngas. The compact size, light weight, low cost and high efficiency of such a compact rotary PSA module compared to other known gas separation systems makes the above first disclosed embodiment of the present syngas generation system particularly suitable for mobile applications, such as onboard systems in vehicles, where minimizing size, weight and cost are important considerations for the function and economic feasibility of the system.

The system according to the first embodiment optionally also may include a desulfurization module, installed upstream of the reforming reactor to reduce the sulfur level of the hydrocarbon fuel prior to reforming.

The system also optionally may include a water gas shift (WGS) reactor installed between the reformer and the gas separation means to shift carbon monoxide gas in the reformate to produce more hydrogen gas, which is a desired component of the product synthesis gas mixture.

Additionally, the system optionally may include heat exchangers to cool or heat the process gas at specific stages of the system, according to system process requirements, such as a heat exchanger between the reformer and gas separation means to cool the reformate prior to separation, or a heat exchanger after the gas separation means to heat the product synthesis gas prior to reaction in the downstream ammonia reactor vessel, and/or compression machinery such as centrifugal compressors to vary the pressure of the reformate or product syngas pressures as required at specific stages of the system.

In a preferred version of the first embodiment of the disclosure as described above, a compact ammonia syngas generation system is provided comprising a desulfurization module, CPO reactor, WGS reactor, compact rotary PSA module, product gas compressor, and heat exchangers upstream and downstream of the PSA module, to reform diesel fuel and purify the reformate to produce a syngas mixture enriched in hydrogen and nitrogen components, wherein the hydrogen and nitrogen components of the syngas are present in an approximately 3:1 stoichiometric ratio suitable for feed to a downstream process, such as an ammonia reactor vessel. Such a preferred embodiment of the inventive system is particularly suited to mobile applications where low weight and cost, small size, and high efficiency are important considerations for function and economic feasibility. A preferred adsorbent bed structure for the compact rotary PSA module of the inventive systems may include multi-layer laminated adsorbent beds composed of multiple sections. One section of such a preferred bed may contain a carbon monoxide selective adsorbent, such as a copper-containing alumina or zeolite, effective to remove carbon monoxide from the reformate gas, such that carbon monoxide may be adsorbed in the adsorbent bed independent of the progression of adsorption of other gas components such as nitrogen on other adsorbent materials in the adsorber bed. Another section of a preferred bed may contain a nitrogen and/or carbon dioxide adsorbent such as known molecular sieve materials, effective to remove at least a portion of nitrogen and/or carbon dioxide components from the reformate gas.

The stoichiometric ratio of hydrogen-to-nitrogen in the product syngas from the system of the preferred first embodiment of the disclosure can be varied as required by the downstream systems receiving the syngas by controlling the operation of the compact rotary PSA module to adjust the relative purity of hydrogen in the syngas product, and/or by adjusting the length of the nitrogen and/or carbon dioxide adsorbent section of the adsorbent beds in the PSA module. Through control of the operation of the compact rotary PSA such as by controlling the rotation speed of the rotary valves, and/or control of the duration and/or volume of purge gas used in desorption of the PSA adsorbent beds, the relative hydrogen purity of the syngas product can be actively controlled while maintaining substantially constant syngas product flow. Accordingly, the syngas product from the disclosed systems may be adapted for use in ammonia production, or additional processes other than reaction to form ammonia by adjusting the ratio of hydrogen and nitrogen in the product gas as may be required by such other processes.

In a second embodiment according to the present disclosure, a compact syngas generation system is provided which comprises a compact oxygen enrichment module providing oxygen enriched gas to a reforming reactor which is fluidly coupled to a downstream compact gas separation means. In such an embodiment, the reforming reactor operates to produce a reformate gas containing hydrogen and nitrogen components from a suitable hydrocarbon fuel feedstock and oxygen enriched gas, providing the reformate gas to the compact gas separation means. The compact gas separation means operates to purify the desired hydrogen and nitrogen constituents of the reformate gas to deliver a syngas product having enriched hydrogen and nitrogen components in approximately 3:1 stoichiometric quantities for use in a downstream reactor, while separating contaminant, undesired, or diluent components of the reformate to reduce their concentration in the product syngas mixture.

Suitable reforming reactors for use in the system according to the second embodiment of the disclosure above may include catalytic partial oxidation reactors (CPO), or auto-thermal reforming reactors (ATR), which are operable to reform hydrocarbon fuels, such as diesel fuel, gasoline, natural gas, propane, ethanol, methanol, and combinations thereof, in the oxygen enriched gas to produce reformate gas containing hydrogen and nitrogen components. Such suitable reformers may be adjusted to produce reformate containing hydrogen and nitrogen components in an approximately 3:1 stoichiometric ratio or other ratio as required by considering other pertinent factors, such as downstream process equipment, by varying the proportions and concentrations of oxygen enriched gas and fuel admitted to the reformer. Suitable types of compact oxygen enrichment modules may include oxygen purification membranes or compact oxygen PSA modules, and more particularly compact rotary oxygen PSA modules as generally described above, which may incorporate multi-layer parallel passage adsorbent beds, as described in U.S. Pat. Nos. 6,063,161 and 6,451,095 as described above, and additionally in U.S. Pat. No. 6,406,523 to Keefer et al., which also is incorporated herein in its entirety. Such adsorbent beds may contain adsorbent materials known in the art, as described above, such as, without limitation, molecular sieves, carbon adsorbents, ion-exchanged adsorbents among others, and combinations thereof, which may be selected according to their ability to adsorb contaminant and diluent components of air so as to produce an oxygen-enriched gas product for supply to the reformer. Suitable compact gas separation means may include compact pressure swing adsorption (PSA) modules, and more particularly compact rotary PSA modules incorporating multi-layer parallel passage adsorbent beds, as described above and in the references incorporated above, with adsorbents selected from materials known in the art to be effective to adsorb deleterious or diluent components of the reformate gas mixture, particularly carbon monoxide and carbon dioxide (such as molecular sieves, carbon adsorbents, silicas, carbon monoxide selective adsorbents, and other such adsorbent materials). Due to the same advantages presented above in describing the first disclosed embodiment of the disclosure, the use of such compact gas separation modules makes this second disclosed embodiment of the present syngas generation system particularly suitable for applications requiring compact and low cost syngas generation systems, such as mobile applications, and particularly onboard systems in vehicles.

The system according to this second disclosed embodiment optionally also may include a desulfurization module, WGS reactor, heat exchangers, and/or compression machinery, as are described in the disclosure of the first embodiment, as required within the system according to operating conditions, and requirements of downstream processes using the product syngas, such as ammonia production.

In a preferred version of the second disclosed embodiment, a compact syngas generation system is provided comprising a compact, rotary oxygen enrichment PSA module, desulfurization module, CPO reactor, WGS reactor, compact rotary PSA purification module, product gas compressor, and heat exchangers upstream and downstream of the PSA module, to reform diesel fuel and purify the reformate to produce a syngas mixture enriched in hydrogen and nitrogen components, wherein the hydrogen and nitrogen components of the syngas are present in an approximately 3:1 stoichiometric ratio suitable for feed to a downstream reactor vessel. Such a preferred embodiment of the inventive system is particularly suited to compact applications, such as mobile applications where low weight and cost, small size, and high efficiency are essential for functional and economic feasibility. A preferred adsorbent bed structure for the compact rotary PSA purification module of the preferred second embodiment may include multi-layer, parallel passage adsorbent beds comprising at least one section which incorporates a carbon monoxide and/or carbon dioxide selective adsorbent, such as a copper-containing alumina or zeolite, effective to remove carbon monoxide and/or carbon dioxide from the reformate gas.

In a third disclosed embodiment, a compact syngas generation system is provided which comprises a steam methane reformer (SMR) and ATR reactor, providing reformate to a compact PSA gas separation module, such as a compact rotary PSA module. In such an embodiment, the SMR operates to produce a first reformate gas containing hydrogen and nitrogen components from a hydrocarbon fuel feedstock, such as natural gas (methane), the first reformate gas being provided to the ATR. The ATR operates to produce a second reformate gas from the first reformate gas feedstock, the second reformate containing additional amounts of hydrogen, and nitrogen, such that the stoichiometric ratio of hydrogen to nitrogen in the second reformate gas is approximately 3:1. The second reformate gas from the ATR is provided to the compact PSA gas separation module. The compact PSA gas separation module operates to purify the desired hydrogen and nitrogen constituents of the reformate gas to deliver a syngas product enriched in hydrogen and nitrogen, which remain in approximately 3:1 stoichiometric quantities, and relatively free of deleterious and diluent gas components, for use in a downstream process, such as ammonia production.

As described above in a second embodiment, suitable compact PSA gas separation means for use in the present third embodiment may include compact rotary PSA modules incorporating multi-layer parallel passage adsorbent beds, with adsorbents selected from materials known in the art to be effective to adsorb deleterious or diluent components of the reformate gas mixture, particularly such as carbon monoxide and carbon dioxide. The system according to this third embodiment of the present disclosure may optionally also include a desulfurization module upstream of the SMR, a WGS reactor downstream of the ATR, heat exchangers, and/or compression machinery, as are described in the disclosure of the first embodiment, as required within the system according to operating conditions, and requirements of downstream processes using the product syngas, such as ammonia production.

In a preferred version of the third embodiment of the disclosure as described above, a compact syngas generation system is provided comprising a desulfurization module, SMR, ATR, WGS reactor, compact rotary PSA purification module, product gas compressor, and heat exchanger downstream of the PSA module, to reform natural gas (methane) fuel and purify the reformate to produce a syngas mixture enriched in hydrogen and nitrogen components, wherein the hydrogen and nitrogen components of the syngas are present in an approximately 3:1 stoichiometric ratio suitable for feed to a downstream reactor vessel. A preferred adsorbent bed structure for the compact rotary PSA purification module of the preferred second embodiment may include multi-layer laminated adsorbent beds comprising at least one section, which incorporates a carbon monoxide and/or carbon dioxide selective adsorbent, such as a copper-containing alumina or zeolite, effective to substantially remove carbon monoxide and/or carbon dioxide from the reformate gas.

In a fourth disclosed embodiment, a compact syngas generation system is provided which comprises a reforming reactor coupled with a metal hydrogen purification membrane, and a compact PSA nitrogen enrichment module, such as a compact rotary nitrogen PSA module providing nitrogen enriched gas to the product gas of the metal membrane. In such an embodiment, the reforming reactor operates to produce a reformate gas containing hydrogen from a suitable hydrocarbon fuel feedstock, providing the reformate gas to the coupled metal membrane. The metal membrane operates to separate and purify the hydrogen from reformate, providing a relatively pure hydrogen product gas, to which nitrogen enriched gas from the compact nitrogen enrichment module is added to deliver a syngas product having hydrogen and nitrogen components in approximately 3:1 stoichiometric quantities for use in a downstream reactor.

Suitable reforming reactors for use in the system according to the fourth embodiment of the disclosure above may include CPOs, ATRs, and SMRs, which are operable to reform hydrocarbon fuels such as diesel fuel, gasoline, natural gas, propane, ethanol, methanol, and combinations thereof, to produce reformate gas containing a hydrogen component. Suitable types of metal membranes for hydrogen separation and purification may include palladium membranes. The compact PSA nitrogen enrichment module may more particularly comprise a compact rotary PSA nitrogen enrichment module incorporating multi-layer laminated adsorbent beds, as described in U.S. Pat. Nos. 6,063,161 and 6,451,095 as described above, and additionally U.S. Pat. No. 6,406,523 to Keefer et. al. Such adsorbent beds may contain adsorbent materials known in the art, such as molecular sieves, carbon adsorbents, silicas, and ion-exchanged adsorbents, which may be selected according to their ability to adsorb contaminant and diluent components of air so as to produce a nitrogen-enriched gas product for supply to the hydrogen stream produced by the metal membrane. Due to the same advantages explained above in describing the first embodiment of the disclosure, the use of such a compact PSA nitrogen enrichment module makes this fourth embodiment of the present syngas generation system particularly suitable for mobile applications, such as onboard systems in vehicles. The system according to this fourth embodiment optionally also may include a desulfurization module upstream of the reformer, WGS reactor with coupled metal membrane and nitrogen-enriched gas feed from the compact PSA nitrogen enrichment module so as to maintain an approximate 3:1 hydrogen to nitrogen product gas ratio, heat exchanger, and/or compression machinery, as are described in the disclosure of the first embodiment, as may be required within the system according to operating conditions, and requirements of downstream processes using the product syngas, such as ammonia production.

In a preferred version of the fourth embodiment of the disclosure as described above, a compact syngas generation system is provided comprising a desulfurization module, CPO reactor with coupled palladium hydrogen purification membrane, WGS reactor with coupled palladium membrane, compact rotary PSA nitrogen enrichment module, product gas compressor, and heat exchanger, to reform diesel fuel and purify the reformate to produce a syngas mixture enriched in hydrogen and nitrogen components, wherein the hydrogen and nitrogen components of the syngas are present in an approximately 3:1 stoichiometric ratio suitable for feed to a downstream reactor vessel. Such a preferred embodiment of the inventive system is particularly suited to compact applications such as mobile applications where low weight and cost, small size, and high efficiency are essential for functional and economic feasibility.

### BRIEF DESCRIPTION OF FIGS.

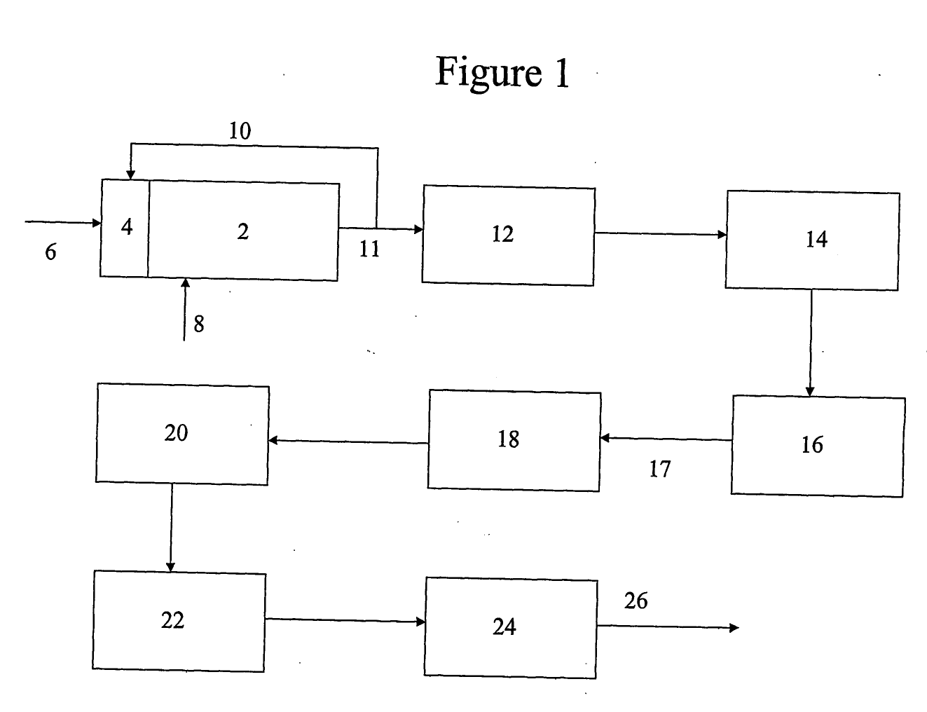

FIG. 1 is a schematic diagram of a preferred version of the first embodiment of the presently disclosed compact syngas generation system.

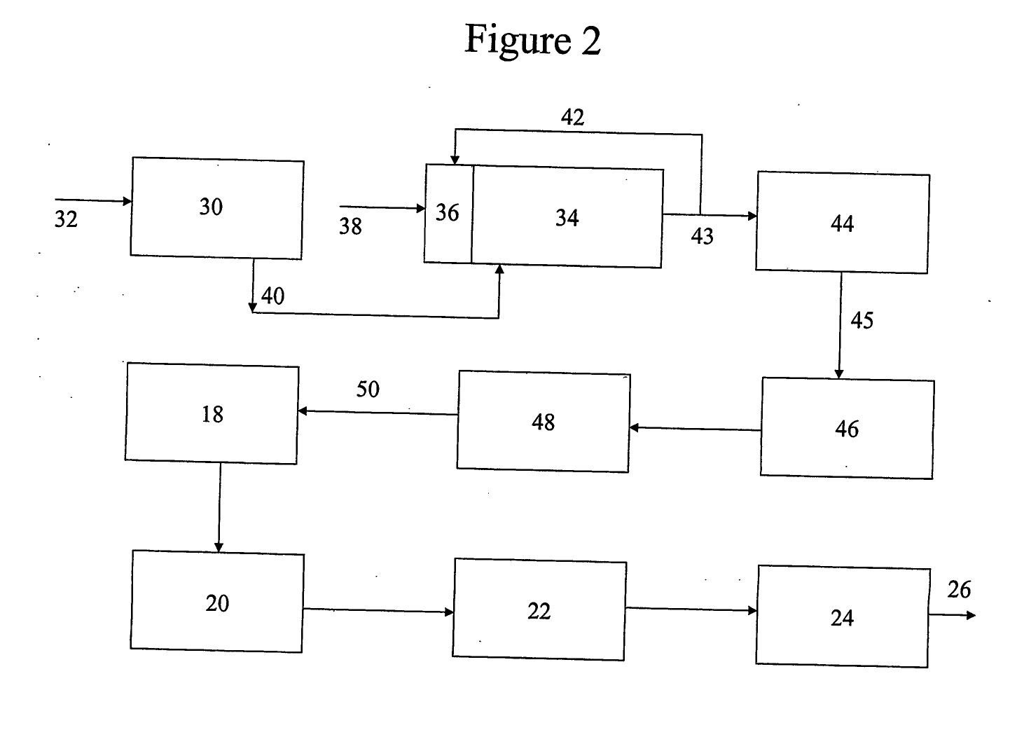

FIG. 2 is a schematic diagram of a preferred version of the second embodiment of the presently disclosed compact syngas generation system.

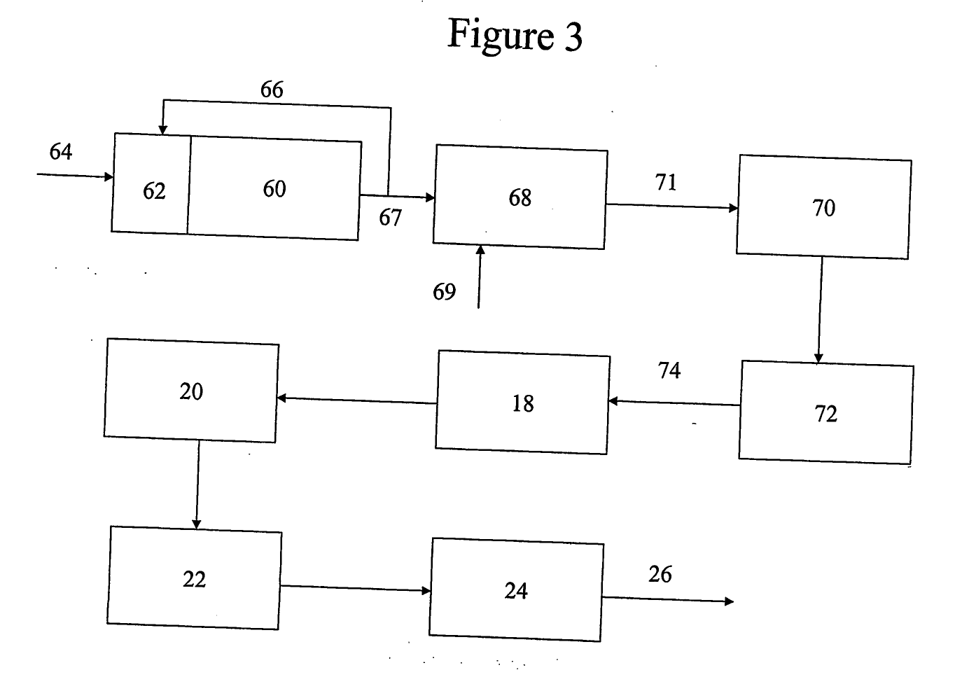

FIG. 3 is a schematic diagram of a preferred version of the third embodiment of the presently disclosed compact syngas generation system.

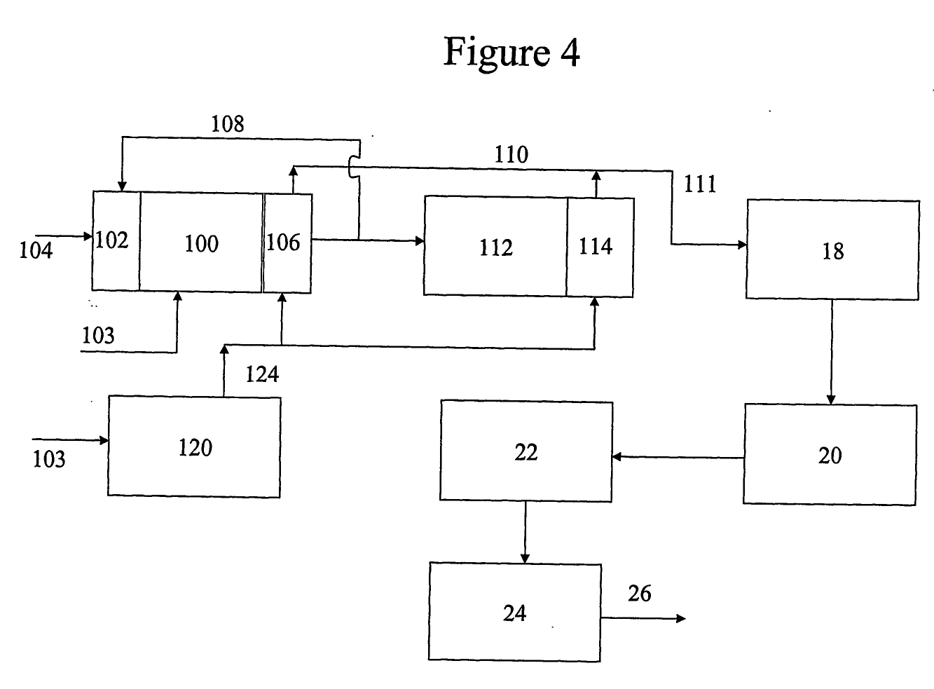

FIG. 4 is a schematic diagram of a preferred version of the fourth embodiment of the presently disclosed compact syngas generation system.

### DETAILED DESCRIPTION OF SEVERAL EMBODIMENTS

According to the particular example of a first embodiment of the present invention depicted in FIG. 1, the inventive system comprises CPO reforming reactor 2 which may be equipped with an integrated desulfurization module (DS) 4 for substantially removing sulfur from incoming fuel stream 6. Alternatively, reactor 2 may comprise an ATR reforming reactor. Fuel stream 6 may comprise any hydrocarbon fuel, such as diesel, suitable for reacting in reactor 2 to produce reformate stream 11 comprising hydrogen and nitrogen.

Optionally, a portion of reformate stream 11 may be recycled to the DS module 4 by means of recycle stream 10. Reformate stream 11 then may be passed through WGS reactor 12 and heat exchanger 14 prior to entering compact rotary hydrogen PSA 16 whereby at least a portion of the non-hydrogen gas species (which typically may include carbon monoxide, carbon dioxide and nitrogen) present in the reformate are adsorbed on suitable adsorbent materials to produce synthesis gas stream 17 suitable for ammonia synthesis reaction, which comprises approximately 75% hydrogen and 25% nitrogen. Synthesis gas stream 17 may be compressed in compressor 18 and passed through heat exchanger 20 prior to being reacted to form ammonia gas in ammonia synthesis reactor 22. Ammonia product gas may then be stored in ammonia storage module 24 prior to use as final ammonia gas product 26.

According to the particular example of a second embodiment of the present invention depicted in FIG. 2, the inventive system comprises CPO reforming reactor 34, which may be equipped with an integrated DS module 36 for substantially removing sulfur from incoming fuel stream 38. Alternatively, reactor 34 may comprise an ATR reforming reactor. Fuel stream 38 may comprise any hydrocarbon fuel, such as diesel, suitable for reacting in reactor 34 to produce reformate stream 43 comprising hydrogen and nitrogen. In this case, reactor 34 may be supplied with an oxygen enriched air stream 40 from compact rotary oxygen enrichment PSA 30 operating to enrich oxygen from air stream 32. Optionally, a portion of reformate stream 43 may be recycled to the HDS module 36 by means of recycle stream 42. Reformate stream 43 may then be passed through WGS reactor 44 to produce gas mixture 45 comprising hydrogen and nitrogen components in an approximately 3:1 stoichiometric ratio, respectively. Gas mixture 45 may then pass through heat exchanger 46 prior to entering compact rotary PSA 48 whereby at least a portion of the non-hydrogen and nitrogen gas species (which may typically include carbon monoxide, carbon dioxide) present in the reformate are adsorbed on suitable adsorbent materials to produce synthesis gas stream 50 suitable for ammonia synthesis reaction, which comprises approximately 75% hydrogen and 25% nitrogen. Synthesis gas stream 50 may be compressed in compressor 18 and pass through heat exchanger 20 prior to being reacted to form ammonia gas in ammonia synthesis reactor 22. Ammonia product gas may then be stored in ammonia storage module 24 prior to use as final ammonia gas product 26.

According to the particular example of a third embodiment of the present invention depicted in FIG. 3, the inventive system comprises SMR reforming reactor 60, which may be equipped with an integrated DS module 62 for substantially removing sulfur from incoming fuel stream 38. Fuel stream 38 may comprise a hydrocarbon fuel, typically natural gas or other methane based fuel, suitable for reacting in SMR 60 to produce SMR reformate stream 67 comprising hydrogen and nitrogen. Optionally, a portion of SMR reformate stream 67 may be recycled to the DS module 62 by means of recycle stream 66. In this case, ATR reactor 68 may be installed downstream of SMR 60 to react SMR reformats stream 67 with air stream 69 to produce secondary reformate stream 71 comprising hydrogen and nitrogen components in an approximately 3:1 stoichiometric ratio. Secondary reformate stream 71 then may be passed through WGS reactor 44 prior to entering compact rotary PSA 72 whereby at least a portion of the non-hydrogen and nitrogen gas species (which typically may include carbon monoxide, carbon dioxide) present in the reformate are adsorbed on suitable adsorbent materials to produce synthesis gas stream 74 suitable for ammonia synthesis reaction, which comprises approximately 75% hydrogen and 25% nitrogen. Synthesis gas stream 74 may be compressed in compressor 18 and passed through heat exchanger 20 prior to being reacted to form ammonia gas in ammonia synthesis reactor 22. Ammonia product gas then may be stored in ammonia storage module 24 prior to use as final ammonia gas product 26.

According to the particular example of a fourth embodiment of the present invention depicted in FIG. 4, the inventive system comprises CPO reforming reactor 100, which may be equipped with an integrated DS module 102 for substantially removing sulfur from incoming fuel stream 104. Fuel stream 104 may comprise a hydrocarbon fuel, such as diesel, gasoline, natural gas or methanol among others, suitable for reacting with air stream 103 in reactor 100 to produce a reformate stream comprising a hydrogen component. Alternatively, reactor 100 may be an ATR or SMR reforming reactor suitable to produce a hydrogen containing reformate stream from fuel 104. Reforming reactor 100 is coupled to metal membrane hydrogen purifier 106, such as a palladium membrane purifier, which is suitable to remove impurities from the reactor reformate stream to produce purified hydrogen stream 110. Optionally, a portion of membrane exhaust gas 113 may be recycled to the DS module 102 by recycle stream 108. In this case, WGS reactor 112 with coupled palladium membrane purifier 114 may be installed downstream of reforming reactor 100 and membrane purifier 106 to react membrane exhaust gas 113 to produce secondary reformate stream 115 to add to hydrogen stream 110 to produce synthesis gas stream 111, which comprises approximately 75% hydrogen and 25% nitrogen. Compact rotary nitrogen PSA 120 functions to adsorptively separate nitrogen from air feed 103 on suitable adsorbent materials to produce nitrogen gas stream 124 in desired quantities and purities, such as substantially pure nitrogen gas, which is supplied to membrane purifiers 106 and 114, to comprise the nitrogen component of synthesis gas stream 111. Synthesis gas stream 74 may be compressed in compressor 18 and pass through heat exchanger 20 prior to being reacted to form ammonia gas in ammonia synthesis reactor 22. Ammonia product gas then may be stored in ammonia storage module 24 prior to use as final ammonia gas product 26.

Having described the principles of the disclosure with reference to several embodiments, it will be apparent to those of ordinary skill in the art that the invention may be modified in arrangement and detail without departing from such principles.

1. A compact synthesis gas generation system suitable for providing a synthesis gas for downstream use in a chemical reaction, comprising:
a reforming reactor suitable to reform a hydrocarbon fuel to produce a reformate gas comprising at hydrogen, nitrogen and impurities;
a compact pressure swing gas purification module suitable to adsorptively remove at least a portion of the impurities from the reformate gas;
wherein the compact pressure swing gas separation module is operable to control the bulk composition of the synthesis gas by selectively controlling the degree of adsorptive removal of nitrogen from the reformate gas.

2. The compact synthesis gas generation system of claim 1 wherein the compact pressure swing gas separation module is a compact rotary pressure swing gas separation module comprising at least one rotary valve.

3. The compact synthesis gas generation system of claim 2 wherein the compact rotary pressure swing gas separation module operates at a cycle speed of at least 1 cycle per minute.

4. The compact synthesis gas generation system of claim 2 wherein the reforming reactor is chosen from the group comprising:
a catalytic partial oxidation reactor, an autothermal reforming reactor and a steam methane reforming reactor.

5. The compact synthesis gas generation system of claim 4 wherein the reforming reactor incorporates a desulfurization module.

6. The compact synthesis gas generation system of claim 3 wherein the compact rotary pressure swing gas separation module comprises at least one parallel passage adsorbent bed.

7. The compact synthesis gas generation system of claim 6 wherein the at least one parallel passage adsorbent bed comprises at least one adsorbent material from the group comprising molecular sieves, activated carbon, carbon molecular sieves, silica, and alumina.
